(19) United States
(12) Patent Application Publication
(10) Pub. No.: US 2015/0128073 A1
(43) Pub. Date: May 7, 2015

(54) METHOD FOR SHARING CONTENTS AND ELECTRONIC DEVICE THEREOF

(71) Applicant: Samsung Electronics Co., Ltd., Gyeonggi-do (KR)

(72) Inventors: Hyung-Ki Ahn, Seoul (KR); Na-Young Kim, Seoul (KR); Nam-Hoi Kim, Gyeonggi-do (KR); Hyun-Young Yang, Seoul (KR); Sang-Hyun Lee, Gyeonggi-do (KR); Yong-Whi Lee, Seoul (KR); Ji-Won Lee, Gyeonggi-do (KR); Hak-Hyeon Jeong, Seoul (KR); Soo-Hwan Chae, Seoul (KR)

(21) Appl. No.: 14/530,537

(22) Filed: Oct. 31, 2014

(30) Foreign Application Priority Data
Nov. 1, 2013 (KR) 10-2013-0132520

(51) Int. Cl. G06F 3/0481; G06F 3/0488

(52) U.S. Cl. CPC G06F 3/0481; G06F 3/0488
USPC 715/759

(57) ABSTRACT

A method of sharing contents and an electronic device thereof are provided. The method includes displaying a shared screen including one or more pages, each of the one or more pages including contents, transmitting the shared screen to a server, and receiving an update shared screen including update contents for the contents of the shared screen from the server, wherein the update contents are updated by one or more other electronic devices.

### PRIORITY

The present application is related to and claims the benefit under 35 U.S.C. §119(a) of a Korean patent application filed in the Korean Intellectual Property Office on Nov. 1, 2013 and assigned Serial No. 102013-0132520, the entire disclosure of which is hereby incorporated by reference.

### TECHNICAL FIELD

The present disclosure relates to a method for sharing contents and an electronic device thereof.

### BACKGROUND

Recently, multimedia technologies have been developed, electronic devices, each of them for various functions, have been released to the market. In general, each of these electronic devices has a convergence function for complexly performing one or more functions.

In addition, the electronic devices mainly feature mobile terminals classified roughly into the so-called “smart phones”. Particularly, each of these mobile terminals has a display module of a large screen touch type and has a high-pixel camera module as well as a basic function like communication with a counterpart. Accordingly, the mobile terminal may capture still and moving pictures. Also, the mobile terminal may reproduce multimedia contents such as music and moving pictures. Also, the mobile terminal may connect to a network and perform web surfing.

This electronic device is gradually advanced to perform various convergence functions more quickly by having a high-performance processor.

### SUMMARY

To address the above-discussed deficiencies, it is a primary object to provide a method of sharing contents to update contents in real time and an electronic device thereof.

Another aspect of the present disclosure is to provide a method of sharing contents to improve security and an electronic device thereof.

Another aspect of the present disclosure is to provide a user interface for intuitively operating contents in an electronic device.

In accordance with an aspect of the present disclosure, an operation method of an electronic device is provided. The operation method includes displaying a shared screen including one or more pages, each of them including contents, transmitting the shared screen to a server, and receiving an update shared screen including update contents for the contents of the shared screen from the server, wherein the update contents are updated by one or more second electronic devices.

In accordance with another aspect of the present disclosure, an electronic device is provided. The electronic device includes a touch screen, a memory, and at least one processor, wherein at least the one processor displays a shared screen including one or more pages, each of them including contents, transmits the shared screen to a server, and receives an update shared screen including update contents for the contents of the shared screen from the server and wherein the update contents are updated by one or more second electronic devices.

In accordance with another aspect of the present disclosure, an operation method of a server is provided. The operation method includes receiving a shared screen, including one or more pages, each of them including contents, from an electronic device, transmitting the shared screen to a second electronic device, receiving an update shared screen including update contents for the contents of the shared screen from the second electronic device, and transmitting the update shared screen to the electronic device.

In accordance with another aspect of the present disclosure, a non-transient computer-readable medium is provided. The non-transient computer-readable medium storing embodied thereon one or more programs comprises instructions for allowing a first electronic device to perform the method of displaying a shared screen including one or more pages, each of them including contents, transmitting the shared screen to a server, and receiving an update shared screen including update contents for the contents of the shared screen from the server, wherein the update contents are updated by one or more second electronic devices.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an electronic device according to one embodiment of the present disclosure;

FIG. 2 illustrates a block diagram of a system of sharing a shared screen according to one embodiment of the present disclosure;

FIG. 3 illustrates a block diagram of a configuration of an electronic device according to one embodiment of the present disclosure;

FIG. 4 illustrates a block diagram illustrating detailed configuration of a processor according to one embodiment of the present disclosure;

FIGS. 5A to 5C illustrate a process of generating a shared screen of an electronic device according to one embodiment of the present disclosure;

FIGS. 6A to 6C illustrate a process of editing a shared screen of an electronic device according to one embodiment of the present disclosure;

FIGS. 7A to 7C illustrate a process of sending an invitation message to a second electronic device in an electronic device according to one embodiment of the present disclosure;

FIGS. 8A and 8B illustrate lock screens before and after receiving an update shared screen of an electronic device according to one embodiment of the present disclosure;

FIG. 9 illustrates configuration of a shared screen according to one embodiment of the present disclosure;

FIG. 10 is a flowchart illustrating an operation method of an electronic device according to one embodiment of the present disclosure;

FIG. 11 is a signal sequence diagram illustrating an operation method among an electronic device, a server, and a second electronic device according to one embodiment of the present disclosure;

FIG. 12 is a flowchart illustrating an operation method of an electronic device according to another embodiment of the present disclosure;

FIGS. 13A to 13C illustrate a table function of contents of a shared screen according to one embodiment of the present disclosure;

FIG. 14 is a flowchart illustrating an operation method of an electronic device according to another embodiment of the present disclosure; and

FIGS. 15A to 15C illustrate an index view function of a shared screen according to one embodiment of the present disclosure.

### DETAILED DESCRIPTION

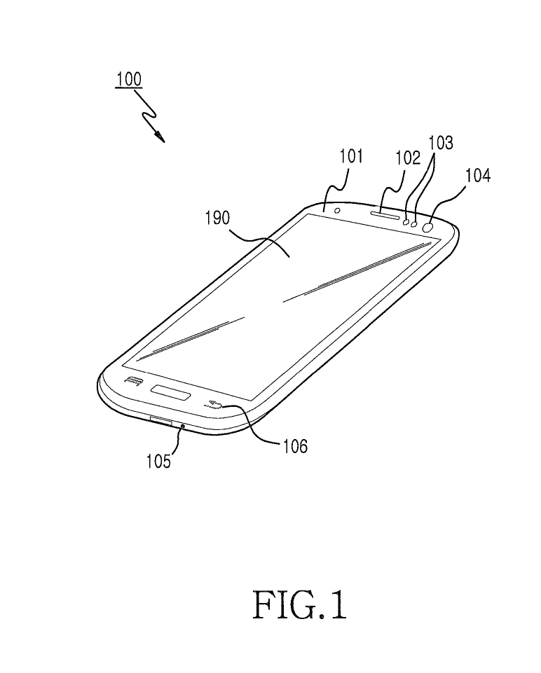

FIGS. 1 through 15C, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device. Exemplary embodiments of the present disclosure will be described herein below with reference to the accompanying drawings. In the following description, well-known functions or constructions are not described in detail since they would obscure the disclosure in unnecessary detail.

In describing various embodiments of the present disclosure, a description will be given for, but is not limited to, an electronic device to which a touch screen as a display unit may be applied. For example, the electronic device may include one or more of a smart phone, a tablet Personal Computer (PC), a mobile phone, a video phone, an e-book reader, a desktop PC, a laptop PC, a netbook computer, a Personal Digital Assistant (PDA), a Portable Multimedia Player (PMP), a Moving Picture Experts Group (MPEG) layer 3 (MP3) player, jewelry, electronic accessories, a camera, a wearable device, a wristwatch, a refrigerator, an air conditioner, a cleaner, a cybot, a TeleVision (TV), a Digital Versatile Disc (DVD) player, an audio, an oven, a microwave oven, a washing machine, an electronic bracelet, an electronic necklace, an air cleaner, an electronic picture frame, medical devices, a navigation device, a satellite signal receiver, an Event Data Recorder (EDR), a Flight Data Recorder (FDR), a set-top box, a TV box, an electronic dictionary, a car infotainment device, electronic equipment for ship, avionics, a security device, electronic clothes, an electronic key, a camcorder, a game console, a Head Mounted Display (HMD), a flat panel display, an electronic album, a part of furniture or a building/structure including an electronic device, an electronic board, an electronic signature receiving device, and a projector, each of them including a touch screen.

FIG. 1 illustrates an electronic device according to one embodiment of the present disclosure.

Referring to FIG. 1, a touch screen 190 may be installed in a front surface 101 of the electronic device denoted by 100. The touch screen 190 may display an electric signal transmitted from the electronic device 100 as images such as texts, graphics, and videos. The touch screen 190 may input and output data simultaneously by applying a touch panel. The touch screen 190 may receive data by an input means such as a finger or stylus pen of a user of the electronic device 100.

An earpiece 102 for receiving voices of the user may be installed at an upper side of the touch screen 190. A plurality of sensors 103 for convenience in use of the electronic device 100, such as a proximity sensor or an illumination sensor, and a camera module 104 for capturing objects may be installed around the earpiece 102.

In accordance with one embodiment of the present disclosure, the touch screen 190 may display a shared screen generated in the electronic device 100. The electronic device 100 may share this shared screen with a counterpart electronic device. For example, the shared screen may include one or more pages, each of them including contents, and include a home screen or a lock screen of the electronic device 100.

The electronic device 100 may further include a microphone device 105, located at a lower side of the touch screen 190, for receiving sounds and a keypad device 106 in which key buttons are allocated. However, electronic device 100 is not limited to them. Various additional devices for implementing well-known additional functions may be further installed in the electronic device 100.

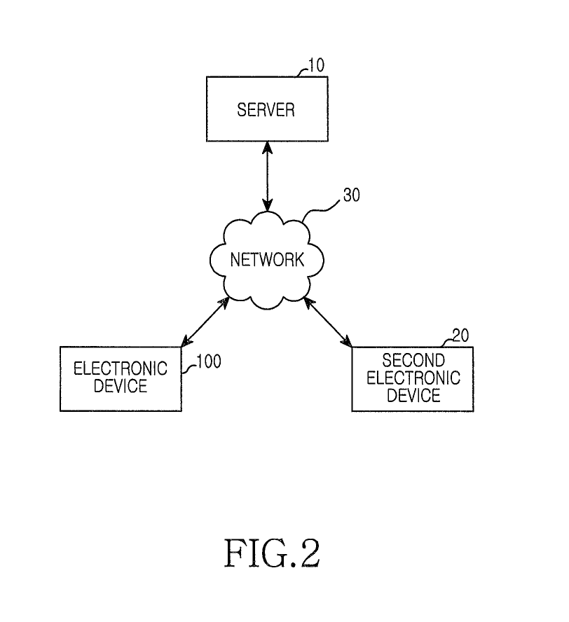

FIG. 2 illustrates a block diagram of a system of sharing a shared screen according to one embodiment of the present disclosure.

Referring to FIGS. 1 and 2, the electronic device 100 may connect with a server 10 or a second electronic device 20 through a certain network 30. The electronic device 100 may transmit and receive files with the server 10 or the second electronic device 20 and share files by connecting with the server 10 or the second electronic device 20. The server 10 may include, but is not limited to, a cloud server of a cloud service type or a server of a context awareness based type which connects to the electronic device 100 through the network 30 and provides various contents.

In accordance with one embodiment of the present disclosure, the electronic device 100 may generate a shared screen including one or more pages, each of them including contents. This shared screen may be transmitted to the server 10 and be then stored in the server 10. The server 10 may transmit the shared screen to a counterpart electronic device (e.g., the second electronic device 20) which is permitted to be shared. The second electronic device 20 may transmit an update shared screen in which the received shared screen is updated to the server 10. The server 10 may store the received update shared screen. The electronic device 100 may receive the update shared screen stored in the server 10 from the server 10.

As described above, the shared screen initially generated by the electronic device 100 may be updated by the second electronic device 20. Also, the server 10 may back up the update shared screen in real time and transmit the update shared screen to the electronic device 100 or the second electronic device 20 in real time. For example, the update shared screen may include one or more pages, each of them including contents and include a home screen or a lock screen of the electronic device 100.

In one embodiment of the present disclosure, the description was given for, but is not limited to, the only the second electronic device 20 as a counterpart electronic device. For example, there may be a plurality of counterpart electronic devices as well as the second electronic device 20. In this case, the server 10 may receive an update shared screen from each of the counterpart electronic devices and store the received update shared screen in real time. Also, the server 10 may transmit an update shared screen to each of the counterpart electronic devices.

The second electronic device 20 may include at least one of various devices, each of them having at least one communication module, such as a PDA, a laptop computer, a mobile phone, a smart phone, a netbook computer, a TV, a Mobile Internet Device (MID), a Ultra Mobile PC (UMPC), a tablet PC, a wristwatch, a camera device, a navigation device, and an MP3 player.

The network 30 may include a wired or wireless network. The network 30 may include at least one of a Global System for Mobile communication (GSM) network, an Enhanced Data GSM Environment (EDGE) network, a Code Division Multiple Access (CDMA) network, a W-CDMA network, a Long Term Evolution (LTE) network, an Orthogonal Frequency Division Multiple Access (OFDMA) network, a Wireless-Fidelity (Wi-Fi) network, a WiMax network, a Near Field Communication (NFC) network, an Infrared Data Association (IrDA) communication, and a Bluetooth network.

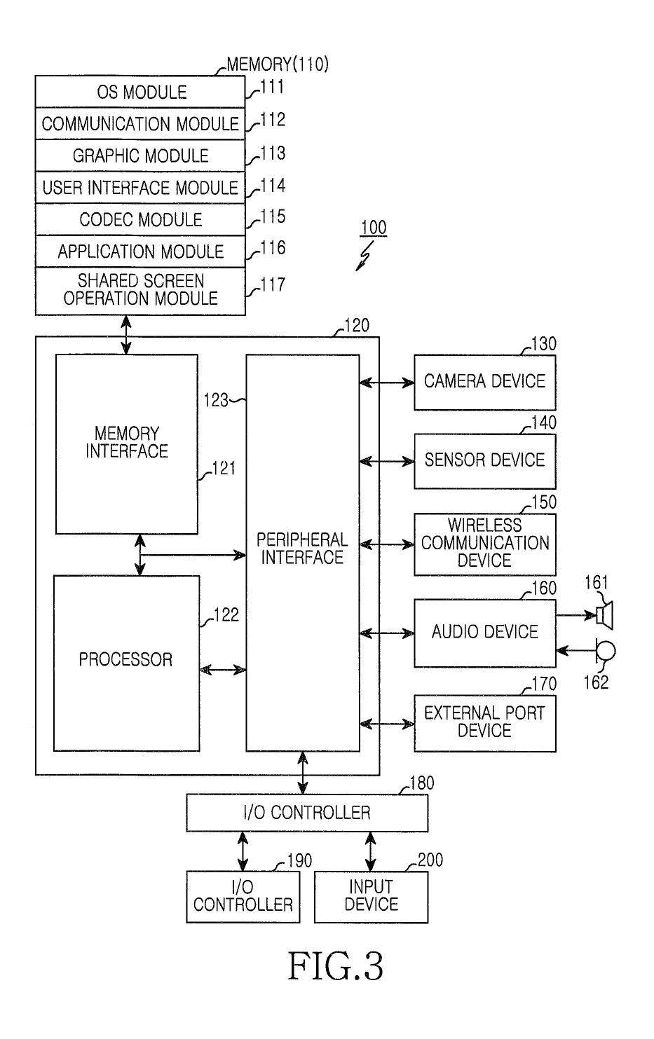

FIG. 3 illustrates a block diagram of an electronic device according to one embodiment of the present disclosure.

Referring to FIGS. 2 and 3, the electronic device 100 may be any one of apparatuses, such as a PDA, a laptop computer, a mobile phone, a smart phone, a netbook computer, a handheld computer, an MID, a media player, a UMPC, a tablet PC, a note PC, a wristwatch, a navigation device, an MP3 player, a camera device, or a wearable device. Also, the electronic device 100 may be a certain device including a device in which two or more functions are combined among these apparatuses.

In accordance with one embodiment of the present disclosure, the electronic device 100 includes a memory 110, a processor unit 120, a camera device 130, a sensor device 140, a wireless communication device 150, an audio device 160, an external port device 170, an Input/Output (I/O) controller 180, a touch screen 190, and an input device 200. The memory 110 and the external port device 170 may be a plurality of memories and external port devices, respectively.

A description will be given for respective components as follows.

The processor unit 120 may include a memory interface 121, at least one processor 122, and a peripheral interface 123. Herein, the memory interface 121, at least the one processor 122, and the peripheral interface 123 which are included in the processor unit 120 may be implemented in at least one Integrated Circuit (IC) or be separately implemented.

The memory interface 121 may controls that a component like the processor 122 or the peripheral interface 123 accesses the memory 110.

The peripheral interface 123 may control connection among I/O peripherals of the electronic device 100, the processor 122, and the memory interface 121.

The processor 122 may perform a control operation to provide various multimedia services using at least one software program. The processor 122 may execute at least one program stored in the memory 110 and provide a service corresponding to the corresponding program. This processor 122 may include one or more Application Processors (APs) or one or more Communication Processors (CPs).

The processor 122 executes several software programs and performs several functions for the electronic device 100. Also, the processor 122 performs process and control for voice, video, and data communication. In addition, the processor 122 may interwork with the software modules stored in the memory 110 and perform the method according to embodiments of the present disclosure.

The processor 122 may include one or more data processors, an image processor, or a COding DECoding (CODEC). In addition, the electronic device 100 may include the data processor, the image processor, or the CODEC separately.

A variety of components of the electronic device 100 may be coupled by one or more communication buses (not written in reference numbers) or electric connection lines (not written in reference numbers).

The camera device 130 may perform a camera function such as a photo and video clip recording function. The camera device 130 may include a Charge Coupled Device (CCD) or a Complementary Metal-Oxide Semiconductor (CMOS), etc. In addition, the camera device 130 may change hardware-like configuration, for example, may adjust lens movement, the number of diaphragms, etc. according to a camera program executed by the processor 122

The camera device 130 may provide collection images acquired by capturing objects to the processor unit 120. The camera device 130 may include an image sensor for converting an optical signal into an electric signal, an image signal processor for converting an analog image signal into a digital image signal, and a digital signal processor for processing images to display the image signal output from the image signal processor on the touch screen 190, etc.

The sensor device 140 may include a proximity sensor, a hall sensor, an illumination sensor, a motion sensor, etc. For example, the proximity sensor may sense an object approached to the electronic device 100. The hall sensor may sense magnetic force of a metal body. Also, the illumination sensor may sense light around the electronic device 100. The motion sensor may include an acceleration sensor or a gyro sensor for sensing motion of the electronic device 100. However, the sensor device 140 is not limited to them. Also, the sensor device 140 may further include various sensors for implementing the well-known additional functions.

The wireless communication device 150 may perform wireless communication and include a Radio Frequency (RF) transceiver or an optical (e.g., infrared ray) transceiver. Although it is not shown in FIG. 3, the wireless communication device 150 may include an RF IC unit and a baseband processing unit. The RF IC unit may transmit and receive electromagnetic waves. The RF IC unit may convert a baseband signal from the baseband processing unit into an electromagnetic wave and transmit the converted electromagnetic wave through an antenna of the electronic device 100.

The RF IC unit may include an RF transceiver, an amplifier, a tuner, an oscillator, a digital signal processor, a CODEC chip set, a Subscriber Identity Module (SIM) card, etc.

The wireless communication device 150 may be implemented to operate through at least one of a Global System for Mobile communication (GSM) network, an Enhanced Data GSM Environment (EDGE) network, a Code Division Multiple Access (CDMA) network, a W-CDMA network, a Long Term Evolution (LTE) network, an Orthogonal Frequency Division Multiple Access (OFDMA) network, a Wireless Fidelity (Wi-Fi) network, a WiMax network, a Near Field Communication (NFC) network, an Infrared Data Association (IrDA) network, and a Bluetooth network. However, wireless communication device 150 is not limited to them. Several communication methods using a protocol for e-mail, instant messaging, or Short Message Service (SMS) may be applied to the wireless communication device 150.

The audio device 160 may connect to a speaker 161 and a microphone unit 162 and perform an audio input and output function, such as a voice recognition function, a voice copy function, a digital recording function, or a phone call function. The audio device 160 may provide an audio interface between a user of the electronic device 100 and the electronic device 100. Also, the audio device 100 may convert a data signal received from the processor 122 into an electric signal and output the converted electric signal through the speaker 161.

The speaker 161 may convert a band of an electric signal into an audio frequency band and output the converted signal. The speaker 161 may be disposed in a front or rear surface of the electronic device 100. The speaker 161 may include a flexible film speaker in which at least one piezoelectric material is attached to one vibration film.

The microphone 162 may convert sound waves transmitted from people or other sound sources into electric signals. The audio device 160 may receive an electric signal from the microphone 162, convert the received electric signal into an audio data signal, and transmit the converted audio data signal to the processor 122. The audio device 160 may include an earphone, an earset, a headset, or a headset which is detachably mounted on the electronic device 100.

The external port device 170 may connect the electronic device 100 to a counterpart electronic device directly or connect the electronic device 100 to a counterpart electronic device indirectly through a network (e.g., the Internet, an intranet, a wireless Local Area Network (LAN), etc.). The external port device 170 may include a Universal Serial Bus (USB) port or a firewire port, etc.

The I/O controller 180 may provide an interface between an I/O device, such as the touch screen 190 and the input device 200, and the peripheral interface 123. The I/O controller 180 may include a touch screen controller and other input device controllers.

The touch screen 190 provides an input and output interface between the electronic device 100 and the user. The touch screen 190 may transmit touch information of the user to the processor 122 by applying touch sensing technologies and show visual information, texts, graphics, or videos, etc. provided from the processor 122 to the user.

The touch screen 190 may display state information of the electronic device 100, characters input by the user, moving pictures, and still pictures. In addition, the touch screen 190 may display information about an application executed by the processor 122.

The touch screen 190 may apply not only capacitive, resistive, infrared, and surface sound wave technologies but also certain multi-touch sensing technologies including other proximity sensor arrays or other elements. This touch screen 190 may be any one of a Liquid Crystal Display (LCD), an Organic Light Emitting Diode (OLED), an Active Matrix Organic Light Emitting Diode (AMOLED), a Thin Film Transistor (TFT)-LCD, a flexible display, a 3-dimensional display.

The touch screen 190 may recognize a touch through a change in physical quantity (e.g., capacitance and resistance, etc.) according to contact of a finger or stylus pen of the user. The touch screen 190 may sense operations such as a flicking operation, a touch and drag operation, a tap operation, a tap and hold operation, a multi-tap operation, a swipe operation, a pinch-in operation, a pinch-out operation, and a long press touch operation. Also, the touch screen 190 may be implemented to recognize hovering input (also referred to as non-contact touch or proximity touch) for sensing that an input means such as a finger or stylus pen of the user is approached within a certain distance with the touch screen.

The input device 200 may provide input data generated by selection of the user to the processor 122 through the I/O controller 180. The input device 200 may include a keypad including at least one hardware button and a touch pad for sensing touch information.

The input device 200 may include an up/down button for controlling volume. In addition, the input device 200 may include at least one of pointer devices such as a push button, a locker button, a locker switch, a thumb-wheel, a dial, a stick, a mouse, a track-ball, or a stylus pen, each of them having a corresponding function.

The memory 110 may include a high-speed Random Access Memory (RAM) such as one or more magnetic disc storages, a non-volatile memory, one or more optical storages, or a flash memory (e.g., a NAND flash memory or a NOR flash memory).

The memory 110 stores software components. The software components include an Operating System (OS) module 111, a communication module 112, a graphic module 113, a user interface module 114, a CODEC module 115, an application module 116, and a shared screen operation module 117. Also, the term “module” may be expressed in a set of instructions, an instruction set, or a program.

The OS module 111 may include an embedded OS such as Windows, Linux, Darwin, RTXC, UNIX, OS X, Android, or VxWorks. The OS module 111 may include several software components for controlling a general system operation. The control of this general system operation may include memory control and management, storage hardware (device) control and management, power control and management, etc. In addition, the OS module 111 may perform a function for smoothly communicating between several hardware components (devices) and software components (modules).

The communication module 112 may communicate with a computer, the server 10 of FIG. 2, and a counterpart electronic device through wireless communication device 150 or the external port device 170.

The graphic module 113 may include several software components for providing and displaying graphics on the touch screen 190. The term “graphics” means texts, webpages, icons, digital images, videos, animations, etc.

The user interface module 114 may include several software components related to a user interface. The user interface module 114 may perform a control operation to display information about an application executed by the processor 122 on the touch screen 190. Also, the user interface module 114 includes contents about whether a state of a user interface is changed to any state or whether a state of a user interface is changed in any condition, etc.

The CODEC module 115 may include software components related to encoding and decoding of video files.

The application module 116 may include a software component for at least one application installed in the electronic device 100. This application may include a browser application, an email application, a phonebook application, a game application, a clip board application, an SMS application, a Multimedia Message Service (MMS) application, a Social Networking Service (SNS) application, an instant message application, a wake-up call application, an MP3 application, a scheduling application, a picture board application, a camera application, a word processing function, a keyboard emulation application, a music player application, an address book application, a touch list application, a widget application, a Digital Right Management (DRM) application, a voice recognition application, a voice copy application, a position determining application, a location based service application, etc. The term “application” may be also expressed in an application program.

The shared screen operation module 117 may include various software components for generating and editing a shared screen. The shared screen operation module 117 may operate contents included in a plurality of pages configuring a shared screen and include an instruction for performing a control operation to display this shared screen on the touch screen 190.

The processor unit 120 may further include additional modules (instructions) in addition to the above-described modules.

A variety of functions of the electronic device 100 may be executed by one or more streaming processing, hardware including an Application Specific Integrated Circuit (ASIC), or software.

Although it is not shown in FIG. 3, the electronic device 100 may include a power system for supplying power to several components included therein. The power system may include a power source (Alternating Current (AC) power source or battery), a power error detecting circuit, a power converter, a power inverter, a charging device, or a power state display device (LED). In addition, the electronic device 100 may include a power management and control device for generating, managing, and distributing power.

In one embodiment of the present disclosure, the description was given for, but is limited to, the components of the electronic device 100. For example, the electronic device 100 may include components which are greater than the number of the components shown in FIG. 3 or components which are less than the number of the components shown in FIG. 3.

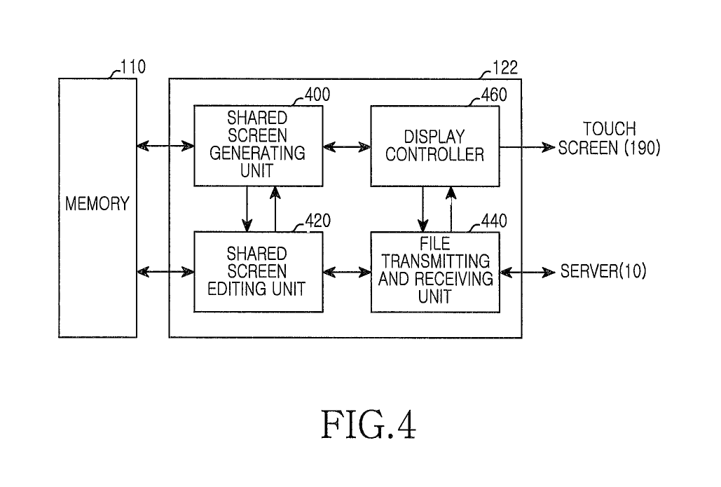

FIG. 4 illustrates a block diagram of detailed configuration of a processor according to one embodiment of the present disclosure.

Referring to FIGS. 2 to 4, the processor 122 may include a shared screen generating unit 400, a shared screen editing unit 420, a file transmitting and receiver 440, and a display controller 460. For example, the shared screen generating unit 400 and the shared screen editing unit 420 may be configured in one module.

The components of the processor 122 may be configured in separate modules. However, in another embodiment of the present disclosure, the components of the processor 122 may be included as components of software in one module.

In accordance with one embodiment of the present disclosure, the shared screen generating unit 400 may generate a shared screen composed of a plurality of pages, each of them including contents. For example, the shared screen may include a home screen or a lock screen of the electronic device 100.

The shared screen generating unit 400 may generate a plurality of pages composing a shared screen. This plurality of pages may include predetermined templates. These templates may include, but are not limited to, Social, Travel, Family Trip, Fashion, etc.

The shared screen generating unit 400 may provide the contents included in the plurality of pages. Contents corresponding to purposes may be set in each of the plurality of pages according to kinds of the templates. These contents may include, but are not limited to, a memo, scheduling, a video clip, a photo album, a Uniform Resource Locator (URL) of a web browser, a map, navigation, SNS information, contact information, e-mail, etc.

The plurality of above-described pages and the above-described contents may be selected by the user of the electronic device 100. Positions of the pages and contents are also set by various methods.

In accordance with one embodiment of the present disclosure, the shared screen editing unit 420 may perform various processes for editing the generated shared screen. The shared screen editing unit 420 may add, delete, or correct a plurality of pages composing the generated shared screen and contents included in the plurality of pages. For example, contents to be added may include various applications such as a photo application, a video application, a scheduling application, a memo application, a clip board application, an SNS information application, and a message application.

In accordance with one embodiment of the present disclosure, the file transmitting and receiving unit 440 may transmit the edited shared screen to the server 10. The server 10 may store the shared screen received from the file transmitting and receiving unit 440 and transmit this shared screen to a counterpart electronic device (e.g., the second electronic device 20) which is permitted to be shared. The second electronic device 20 may transmit an update shared screen in which the received shared screen is updated to the server 10. The server 10 may store the received update shared screen. The file transmitting and receiving unit 440 may receive the update shared screen stored in the server 10 from the server 10.

As described above, the shared screen initially generated by the electronic device 100 may be updated by the second electronic device 20. Also, the server 10 may back up the update shared screen in real time and transmit the update shared screen to the electronic device 100 or the second electronic device 20 in real time.

In accordance with one embodiment of the present disclosure, the display controller 460 may perform a control operation to display the generated shared screen as graphics on the touch screen 190. If a reference gesture is sensed on a corresponding page of the shared screen, the display controller 460 may summarize and show a plurality of pages to recognize the plurality of pages composing the shared screen at a glance. Also, if one of the plurality of summarized pages is selected, the display controller 460 may execute the corresponding page and display the corresponding page on the entire screen.

In one embodiment of the present disclosure, the description was given for, but is limited to, the components of the processor 122. For example, the processor 122 may include components which are greater than the number of the components shown in FIG. 4 or components which are less than the number of the components shown in FIG. 4.

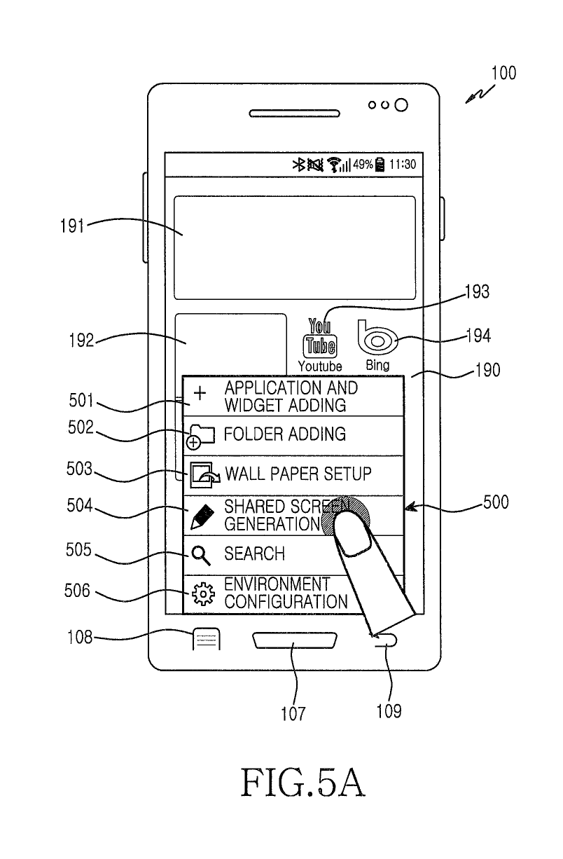

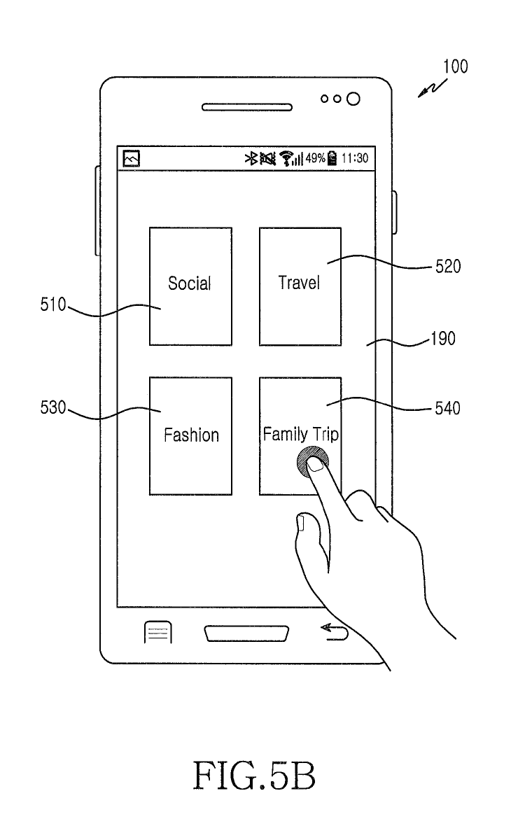

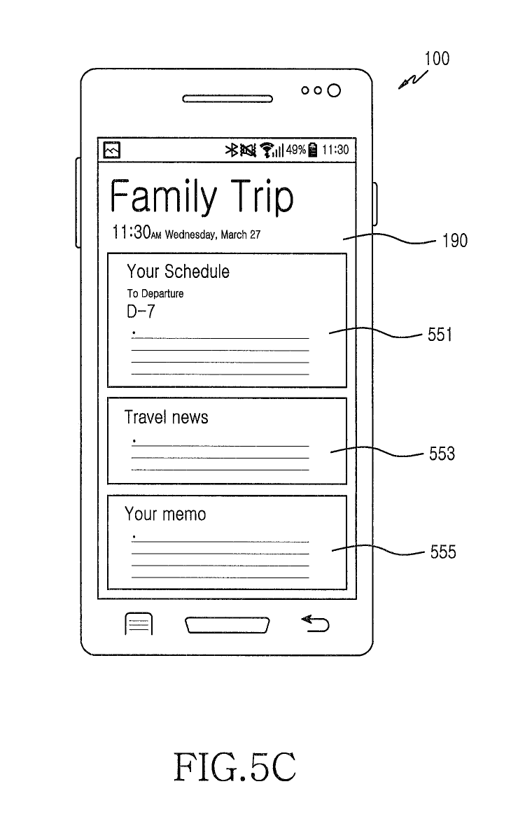

FIGS. 5A to 5C illustrate a process of generating a shared screen of an electronic device according to one embodiment of the present disclosure.

Referring to FIGS. 3 and 5A, the touch screen 190 may be configured as a basic screen (or a home screen) displayed when the electronic device 100 is in a wake-up state. A plurality of objects 191 to 194 may be disposed at a certain interval on the touch screen 190 or a specific region of the touch screen 190. These objects 191 to 194 may be displayed as widget icons 191 and 192 according to settings of a user of the electronic device 100 and icons 193 and 194 for displaying programs.

A physical button 107 for performing a function for changing a screen currently executed on the electronic device 100 to a basic setting screen temporarily or permanently may be disposed at a lower side of the electronic device 100. A button 108 for touch pad for setting programs or functions displayed on the touch screen 190 may be disposed at one end of the physical button 107 and a button 109 for touch pad for cancelling programs or functions displayed on the touch screen 190 may be displayed at the other end of the physical button 107. However, it is not limited to them. It is fine if the buttons 108 and 109 are applied to the well-known buttons.

In accordance with one embodiment of the present disclosure, if the button 108 is selected on the above-described basic screen, a configuration screen list 500 for executing functions of the electronic device 100 may be displayed. An application and widget adding item 501, a folder adding item 502, a wall paper setup item 503, a search item 505, an environment configuration item 506, etc. may be included on this configuration screen list 500. A shared screen generation item 504 according to one embodiment of the present disclosure may be also included on the configuration screen list 500.

When the above-described shared screen generation item 504 is selected, the touch screen 190 may display, as shown in FIG. 5B, pages of previously defined template types. These pages may include, but are not limited to, a social template 510, a travel template 520, a fashion template 530, and a family trip template 540.

When the family trip template 540 is selected among the above-described templates 510, 520, 530, and 540, the touch screen 190 may display, as shown in FIG. 5C, contents 551, 553, and 555 corresponding to a purpose of the corresponding template according to a kind of the corresponding template. These contents 551, 553, and 555 may include the scheduling item 551, the travel news item 553, and the memo item 555. For example, the scheduling item 551 may display schedule registered on the family trip. In the travel news item 553, travel information for destinations may be provided by analyzing e-mail or Short Message Service (SMS) information for the booking of an airline ticket of a travel area.

However, the contents may not be limited to them. The contents may further include a memo, scheduling, a video clip, a photo album, a URL of a web browser, a map, navigation information, Social Networking Service (SNS) information, contact information, e-mail, etc.

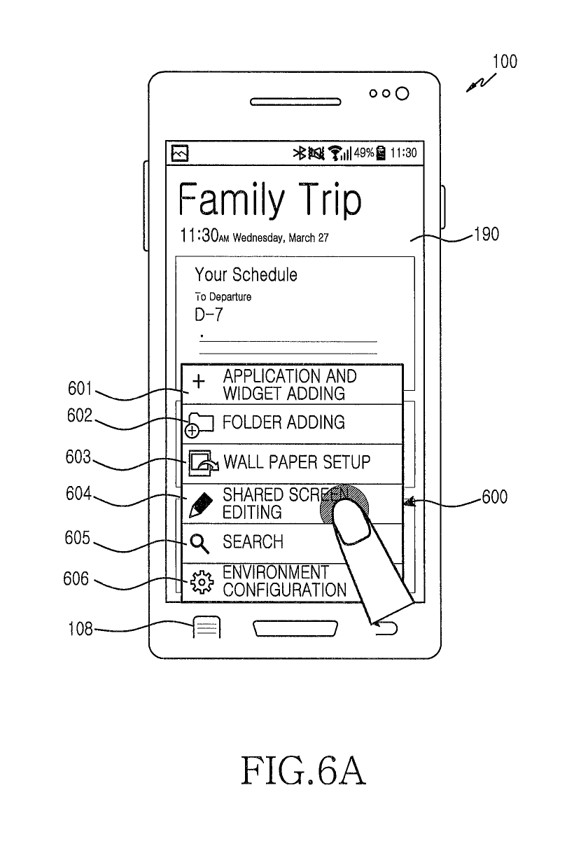

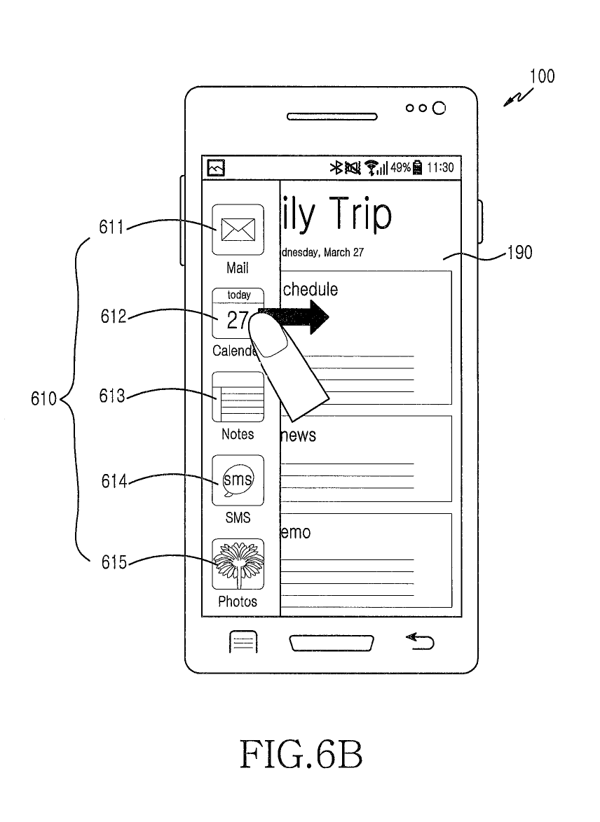

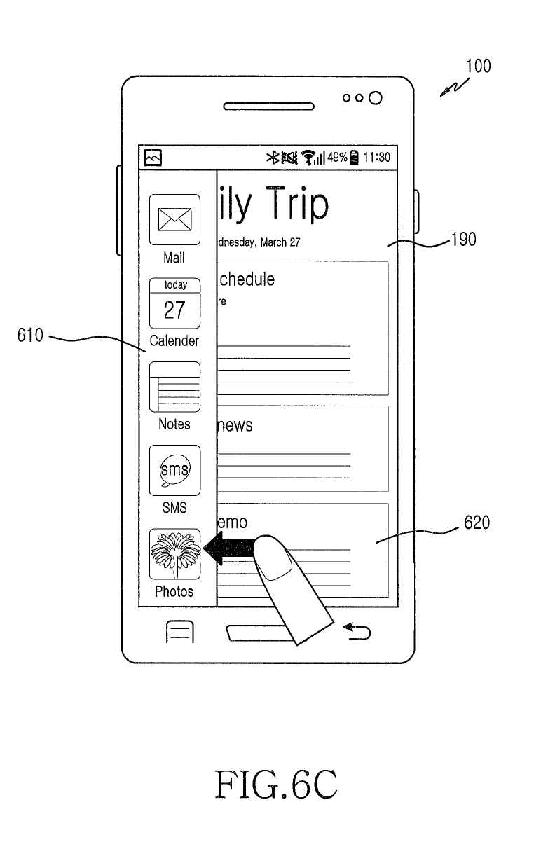

FIGS. 6A to 6C illustrate a process of editing a shared screen of an electronic device according to one embodiment of the present disclosure.

Referring to FIGS. 3 and 6A, when the button 108 is selected on the screen shown in FIG. 5C, the touch screen 190 may display a configuration screen list 600 for executing functions of the electronic device 100. An application and widget adding item 601, a folder adding item 602, a wall paper setup item 603, a search item 605, an environment configuration item 606, etc. may be included on this configuration screen list 600. A shared screen editing item 604 according to one embodiment of the present disclosure may be also included on the configuration screen list 600.

When the above-described shared screen editing item 604 is selected, the touch screen 190 may display, as shown in FIG. 6B, a contents adding list 610 on left region of the touch screen 190. This contents adding list 610 may include, but is not limited to, an e-mail item 611, a calendar item 612, a memo item 613, an SMS item 614, a photo album item 615, etc. For example, the contents adding list 610 may further include various contents such as a photo item, a video item, a scheduling item, a clip board item, an SNS information item, and a message item.

In accordance with one embodiment of the present disclosure, a user of the electronic device 100 may perform a drag and drop operation in a right direction with respect to one 612 of these contents 611 to 615 to generate the corresponding contents 612 additionally. In this case, the additionally generated contents 612 may be automatically resized according to a layout in a predetermined page.

Also, as shown in FIG. 6C, the user may delete corresponding contents 620 through a drag and drop operation to a contents additional list region after performing a long press touch of the corresponding contents 620 in a current page. However, it is not limited to them. Functions of the electronic device 100 may be also changed according to various gestures set by the user.

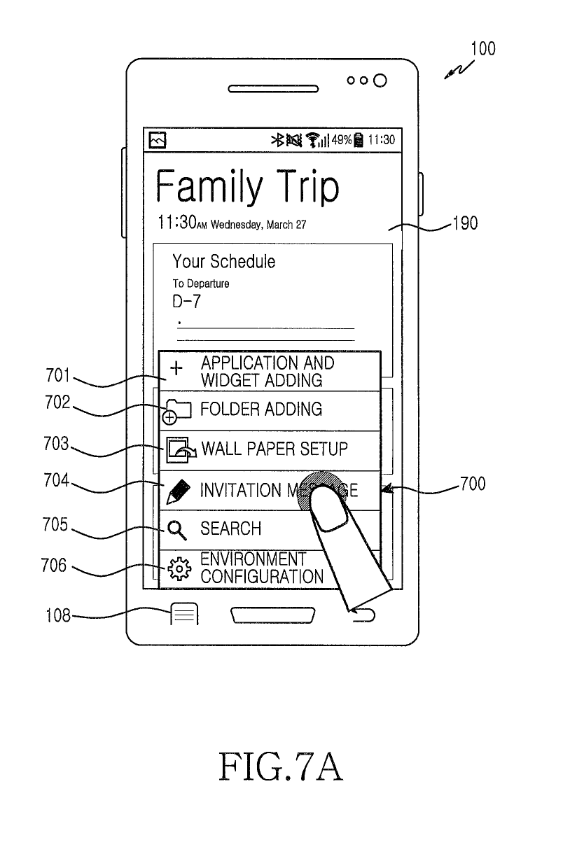

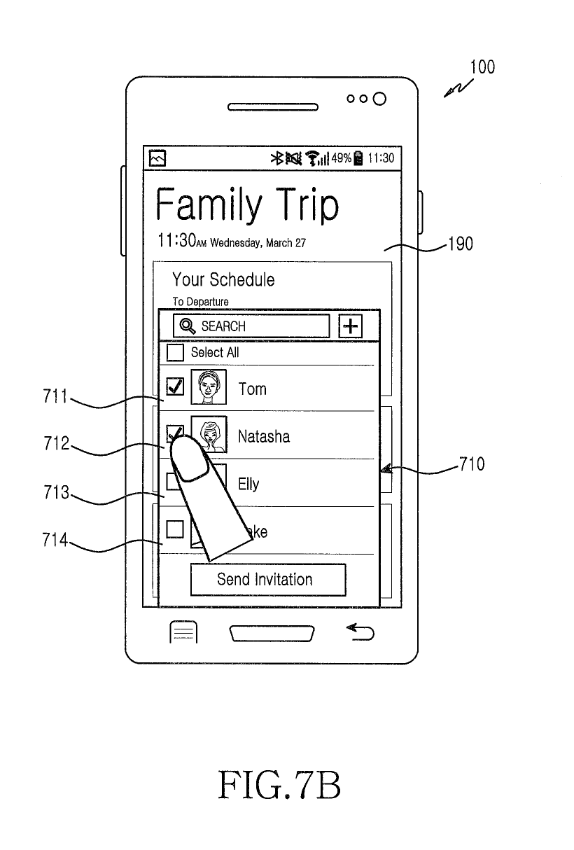

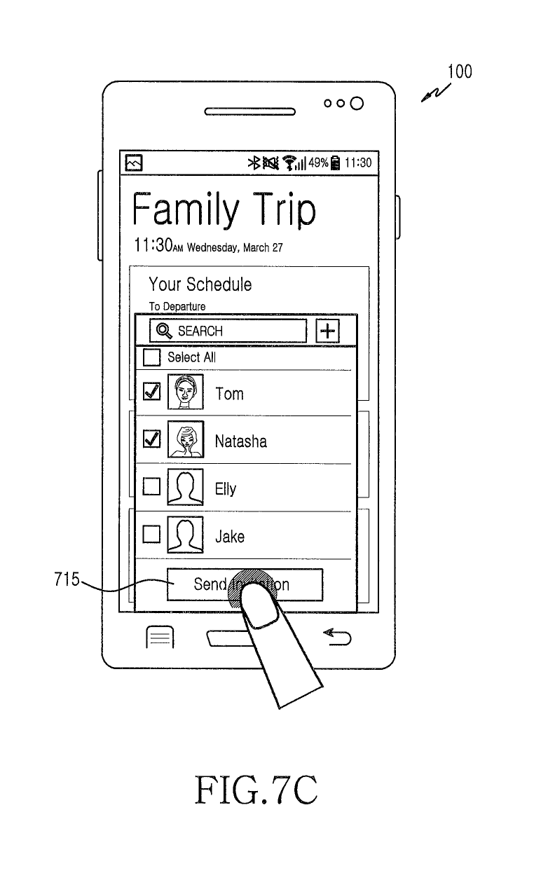

FIGS. 7A to 7C illustrate a process of sending an invitation message to a second electronic device in an electronic device according to one embodiment of the present disclosure.

Referring to FIGS. 2, 3, and 7A, when the button 108 is selected on the screen shown in FIG. 5C, the touch screen 190 may display a configuration screen list 700 for executing functions of the electronic device 100. An application and widget adding item 701, a folder adding item 702, a wall paper setup item 703, a search item 705, an environment configuration item 706, etc. may be included on this configuration screen list 700. An invitation message item 704 according to one embodiment of the present disclosure may be also included on the configuration screen list 700.

When the above-described invitation message item 704 is selected, the touch screen 190 may display, as shown in FIG. 7B, an invitation message list 710. The invitation message list 710 may interwork with a phonebook stored in the memory 110 of the electronic device 100. User information 711 to 714 provided based on contact information may be displayed on the invitation message list 710. For example, the invitation message list 710 may interwork, but is not limited to, acquaintance information or a specific application which is related with an SMS.

In accordance with one embodiment of the present disclosure, a user of the electronic device 100 may select a counterpart he or she wants to share a shared screen with and send a shared screen invitation message to the selected counterpart. For example, the user may select counterparts 711 and 712 to permit to share a shared screen on the invitation message list 710. As shown in FIG. 7C, the user may select an invitation message sending button 715. In this case, the electronic device 100 may send a shared screen invitation message to electronic devices (e.g., the second electronic device 20, etc.) of the selected counterparts 711 and 712.

In accordance with one embodiment of the present disclosure, receiving the shared screen invitation message from the electronic device 100, the second electronic device 20 may receive a shared screen through the server 10. A display unit of the second electronic device 20 may display the same shared screen as the touch screen 190 of the electronic device 100.

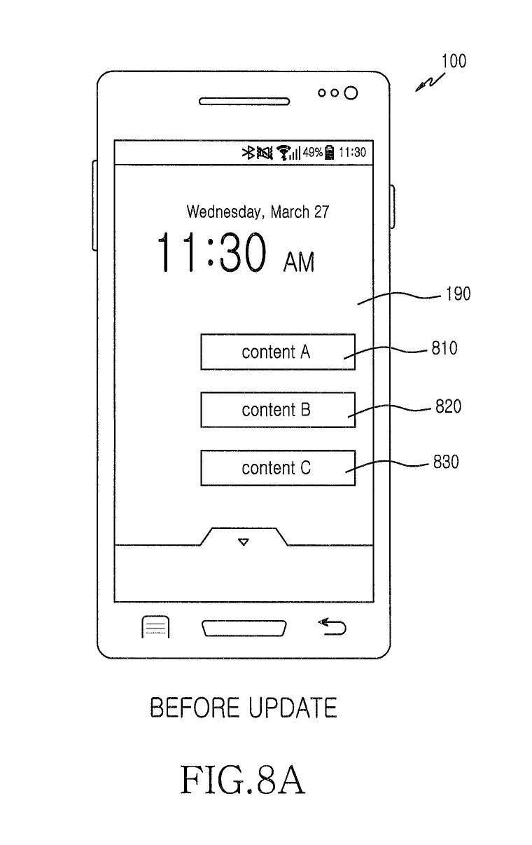

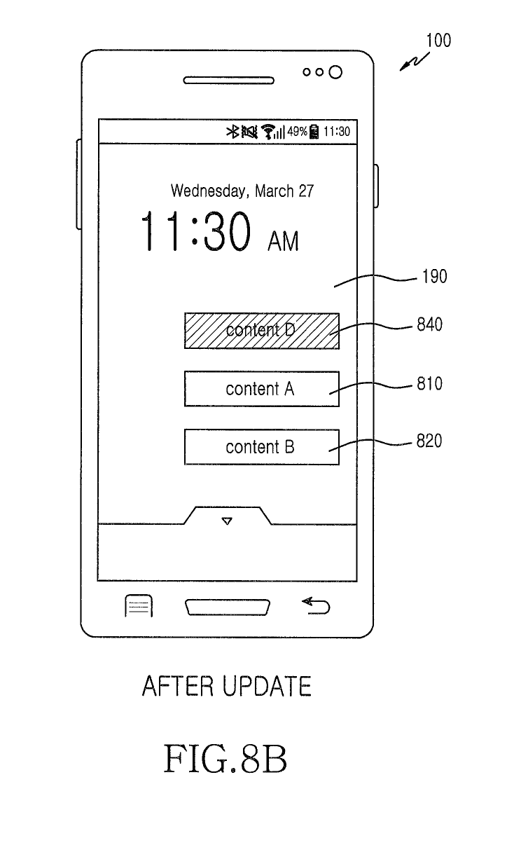

FIGS. 8A and 8B illustrate lock screens before and after receiving an update shared screen of an electronic device according to one embodiment of the present disclosure.

As shown in FIGS. 2, 3, and 8A, the touch screen 190 of the electronic device 100 may display contents related information 810, 820, and 830 included in a plurality of pages of a shared screen. These contents related information 810, 820, and 830 may include, but are not limited to, a title, a summary, or an image of contents. The contents related information 810, 820, and 830 may be disposed on a specific region of the touch screen 190 or at a certain interval on the touch screen 190. The contents related information 810, 820, and 830 may be set by a user of the electronic device 100.

In accordance with one embodiment of the present disclosure, when the electronic device 100 receives an update shared screen from the server 10, the touch screen 190 may display, as shown in FIG. 8B, new contents related information 840. The conventional contents related information 810 and 820 may be changed in their positions. For example, when new contents are pushed from the server 10, the conventional contents related information 810 and 820 may be moved at a certain interval in a lower direction from the conventional position.

In another embodiment of the present disclosure, when the electronic device 100 receives an update shared screen from the server 10 through a roaming service from a foreign country, the touch screen 190 of the electronic device 100 may display contents corresponding to the foreign country. For example, contents which may not be executed through a roaming service, such as a map application, may be updated according to situations of the foreign country. That is, some of contents included in a shared screen at home may differ from contents included in the shared screen in the foreign country. The contents included in the shared screen in the foreign country may be updated according to the local situation.

In accordance with one embodiment of the present disclosure, the server 10 may extract a keyword of contents information to be pushed to the electronic device 100 based on user data/log collected from the electronic device 100 and transmit a wall paper suitable for the corresponding keyword to the electronic device 100. That is, the server 10 may update a lock screen image of the electronic device 100 to correspond to new contents according as a previously stored shared screen is updated.

As shown in FIGS. 8A and 8B, the description was given for, but is not limited to, contents displayed on the lock screen. One embodiment of the present disclosure may be applied to a home screen or any one of a plurality of pages of a shared screen as well as the lock screen.

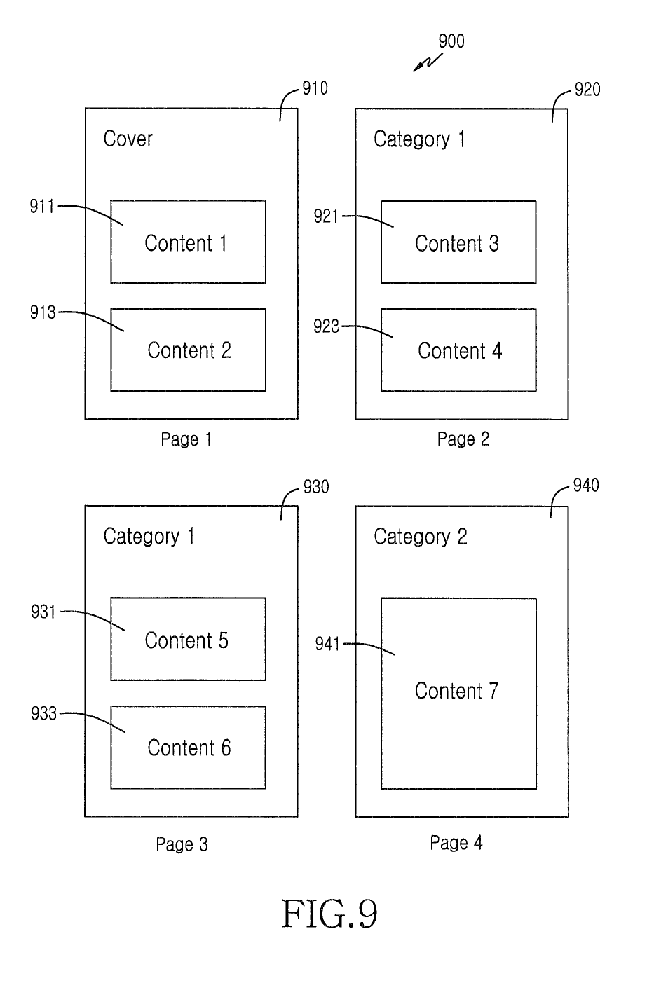

FIG. 9 illustrates configuration of a shared screen according to one embodiment of the present disclosure.

Referring to FIGS. 2 and 9, a shared screen 900 may be composed of a plurality of pages 910, 920, 930, and 940 including contents 911, 913, 921, 923, 931, 933, and 941. The shared screen 900 may include the cover page 910 and the plurality of category pages 920, 930, and 940.

In accordance with one embodiment of the present disclosure, the contents 911 which have the highest priority currently or the predetermined contents 913 may be displayed on the cover page 910. For example, these contents 911 and 913 may include, but are limited to, contents such as scheduling, weather, and the latest SNS feed.

In accordance with one embodiment of the present disclosure, the contents 921, 923, 931, 933, and 941 included in the plurality of category pages 920, 930, and 940 may be automatically classified into categories preset by a user of the electronic device 100. Also, the contents 921, 923, 931, 933, and 941 may be classified while being classified according to categories according to contents information pushed based on contexts and user data of the electronic device 100.

In accordance with one embodiment of the present disclosure, the description was given for, but is not limited to, the shared screen 900 shown as the four pages 910, 920, 930, and 940. For example, the more contents included in the shared screen 900 are increased, the more pages included in the shared screen 900 may be increased.

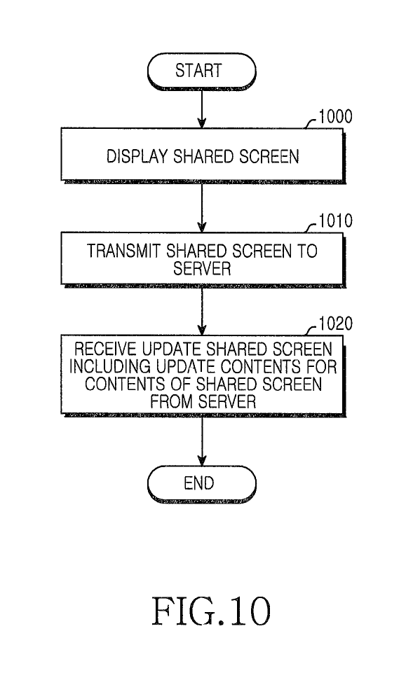

FIG. 10 is a flowchart illustrating an operation method of an electronic device according to one embodiment of the present disclosure.

Referring to FIGS. 2 and 10, the electronic device denoted by 100 may display a shared screen in step 1000.

In accordance with one embodiment of the present disclosure, the electronic device 100 may generate a shared screen including one or more pages, each of them including contents, and display the generated shared screen on the screen of the electronic device 100. For example, as shown in FIG. 5C, the shared screen may be implemented.

Thereafter, the electronic device 100 may transmit the shared screen to the server 10 in step 1010.

In accordance with one embodiment of the present disclosure, the server 10 may store the shared screen received from the electronic device 100 and provide the stored shared screen to the second electronic device 20.

After transmitting the shard screen to the server 10, the electronic device 100 may transmit an invitation message transmission request to the server 10 to transmit sharing authority of the shared screen stored in the server 10 from the server 10 to the second electronic device 20.

Thereafter, the electronic device 100 may receive an update shared screen including update contents for contents of the shared screen from the server 10 in step 1020.

In accordance with one embodiment of the present disclosure, receiving an invitation message from the server 10, the second electronic device 20 may receive the shared screen from the server 10. The second electronic device 20 may update the received shared screen by adding comments to the received shared screen and attaching images to the received shared screen. Also, the second electronic device 20 may transmit the update shared screen to the server 10. The server 10 may store the received update shared screen and transmit the stored shared screen to the electronic device 100.

An instruction set for each of these operations may be stored as one or more modules in the above-described memory 110. In this case, the modules stored in the memory 110 may be executed by the one or more processors 122.

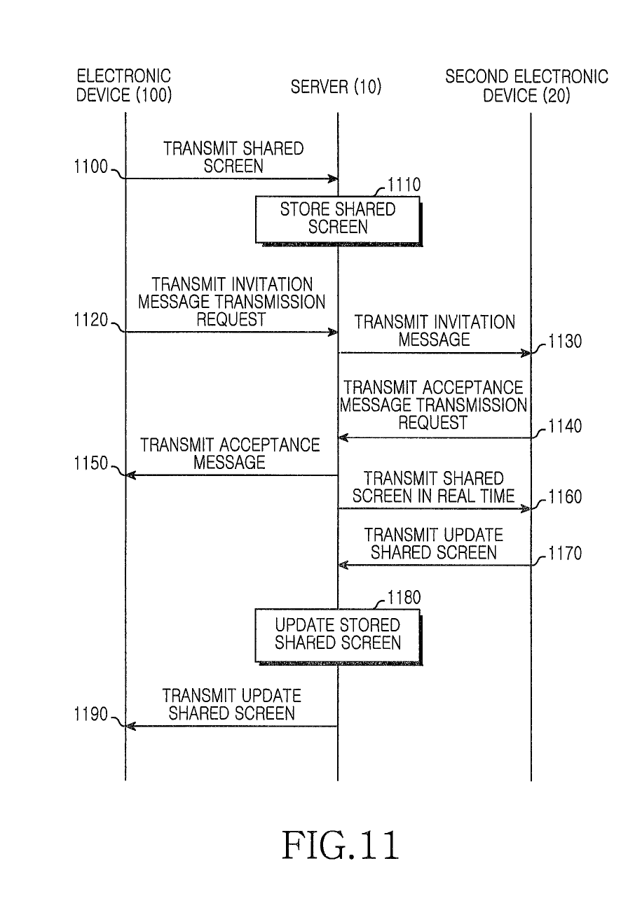

FIG. 11 is a signal sequence diagram illustrating an operation method among an electronic device, a server, and a second electronic device according to one embodiment of the present disclosure.

Referring to FIGS. 2 and 11, the electronic device 100 may transmit a shared screen to the server 10 in step 1100. Herein, the shared screen may include one or more pages, each of them including contents, and include a home screen or a lock screen of the electronic device 100.

Thereafter, the server 10 may store the received shared screen in step 1110. For example, the server 10 may back up the received shared screen in real time.

Thereafter, the electronic device 100 may transmit an invitation message transmission request to the server 10 in step 1120. For example, the electronic device 100 may request the server 10 to transmit sharing authority of the shared screen stored in the server 10 from the server 10 to the second electronic device 20.

Thereafter, the server 10 may transmit an invitation message to the second electronic device 20 in step 1130.

Thereafter, the second electronic device 20 may transmit an acceptance message transmission request to the server 10 in response to the invitation message received from the server 10 in step 1140. For example, the second electronic device 20 may request the server 10 to transmit acceptance completion for the invitation message from the server 10 to the electronic device 100.

Thereafter, the server 10 may transmit an acceptance message to the electronic device 100 in step 1150. Also, the server 10 may transmit the stored shared screen to the second electronic device 20 in real time in step 1160.

Thereafter, the second electronic device 20 may update the shared screen received from the server 10 and transmit the update shared screen to the server 10 in step 1170. For example, the second electronic device 20 may add comments to the received shared screen and attach images to the received shared screen.

Thereafter, the server 10 may update the stored shared screen in step 1180. For example, the server 10 may compare the update shared screen received from the second electronic device 20 with the previously stored shared screen. When there are new contents as a result of the comparison, the server 10 may update the new contents.

Thereafter, the server 10 may transmit the update shared screen to the electronic device 100 in step 1190. For example, the server 10 may provide an update shared screen to the electronic device 100 whenever a previously stored shared screen is updated.

In accordance with one embodiment of the present disclosure, the electronic device 100 may receive the update shared screen updated by the second electronic device 20 in real time through the server 10. Also, the electronic device 100 may display this update shared screen on the screen of the electronic device 100. The electronic device 100 may generate a highlight page or print the highlight page through a printing medium. For example, importance contents may be summarized and shown on the highlight page. The contents may be summarized in the server 10 and the highlight page may be provided to the electronic device 10. The highlight page may display, but is not limited to, a memo, scheduling, a video clip, a photo album, a URL of a web browser, a map, SNS information, an e-mail, contact information, etc. Contents displayed on the highlight page may include contents much shown by other users, contents having high importance such as a video clip, and contents much shared by other users.

In addition, the electronic device 100 may transmit a request for various contents to the server 10, collect core contents, and receive a printing service. However, the electronic device 100 is not limited to them. The electronic device 100 may perform various functions and contents provided through the server 10.

An instruction set for each of these operations may be stored as one or more modules in the above-described memory 110. In this case, the modules stored in the memory 110 may be executed by the one or more processors 122.

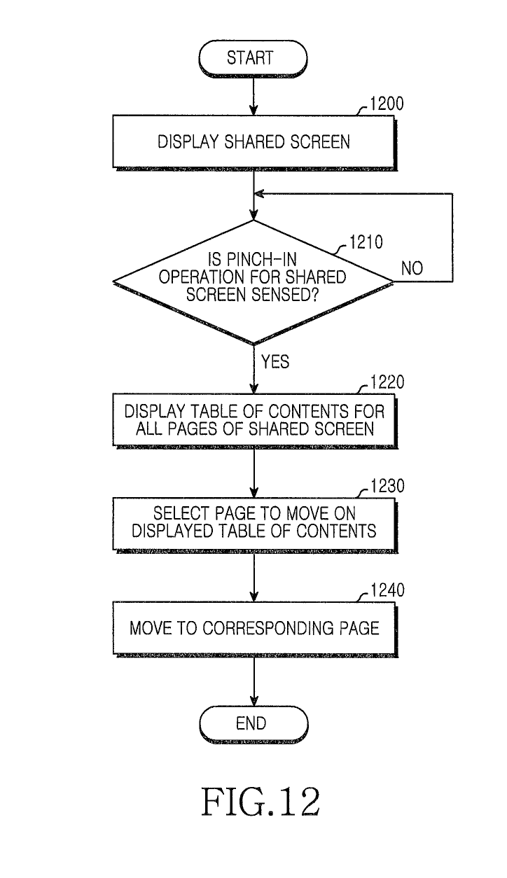

FIG. 12 is a flowchart illustrating an operation method of an electronic device according to another embodiment of the present disclosure.

Referring to FIGS. 2 and 12, the electronic device 100 may display a shared screen in step 1200.

In accordance with one embodiment of the present disclosure, the electronic device 100 may display a shared screen including one or more pages, each of them including contents, on the screen of the electronic device 100. For example, as shown in FIG. 5C, the shared screen may be implemented.

Thereafter, the electronic device 100 may determine whether to sense a pinch-in operation for the shared screen in step 1210.

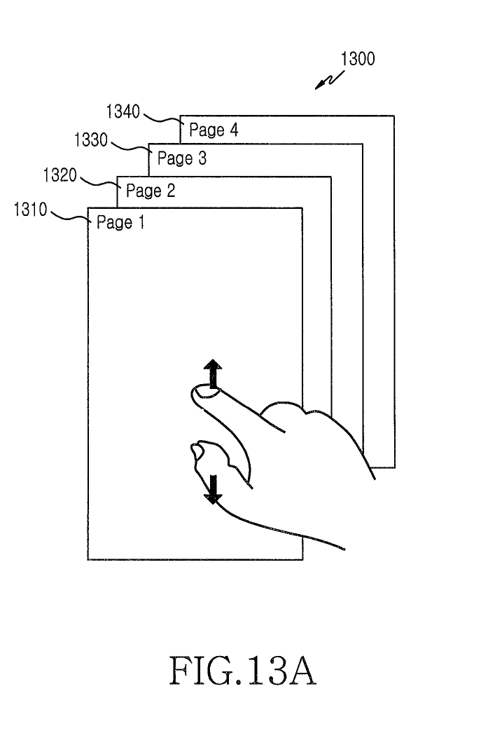

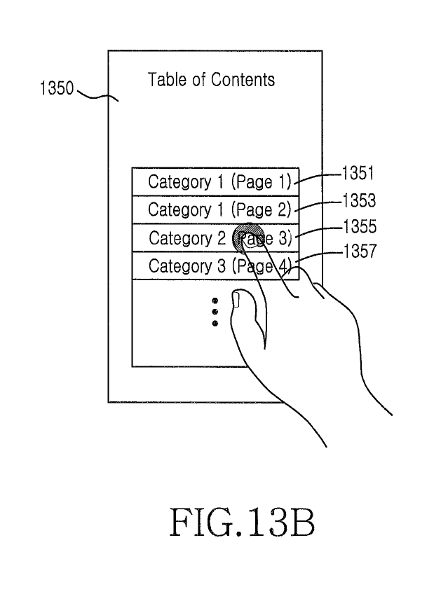

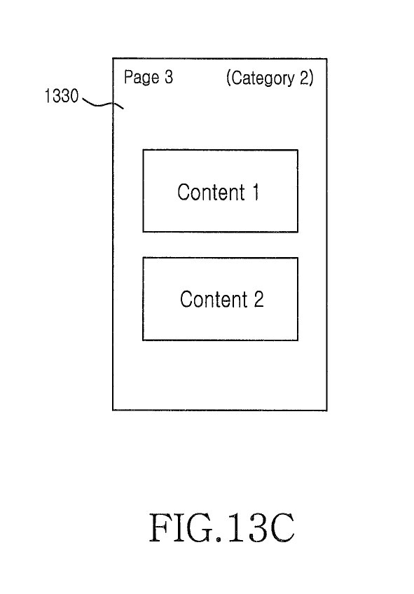

As shown in FIG. 13A, the electronic device 100 may the pinch-in operation for touching two fingers of the user on the screen in each of pages 1310, 1320, 1300, and 1340 of a shared screen 1300 and touching and dragging the two fingers from an inner direction to an outer direction.

Sensing the pinch-in operation for the shared screen, the electronic device 100 may display a table of contents for all pages of the shared screen in step 1220.

As shown in FIG. 13B, the electronic device 100 may display a table of contents 1350 in which the pages 1310, 1320, 1330, and 1340 of the shared screen 1300 are listed. This table of contents 1350 may display category information 1351, 1353, 1355, 1357 corresponding to the pages 1310, 1320, 1330, and 1340 of the shared screen 1300. For example, this category information 1351, 1353, 1355, and 1357 may be disposed on a specific region of the table of contents 1350 or at a certain interval on the table of contents 1350. Shapes and positions of the category information 1351, 1353, 1355, and 1357 may be also set by a user of the electronic device 100.

Also, the category information 1351, 1353, 1355, and 1357 may be arranged in order of high priority or according to settings of the user.

Thereafter, the electronic device 100 may select a page to move on the displayed table of contents in step 1230.

As shown in FIG. 13B, the user of the electronic device 100 may select desired category information 1355 among the category information 1351, 1353, 1355, and 1357 of the table of contents 1350.

Thereafter, the electronic device 100 may move to the corresponding page in step 1240.

As shown in FIG. 13C, the electronic device 100 may display the corresponding page 1330 corresponding to the selected category information 1335. That is, the user may verify whether a desired category is included in any page and move to the corresponding page immediately.

In accordance with one embodiment of the present disclosure, the description was given for, but is not limited to, the method of moving to the desired page through the pinch-in operation. For example, the electronic device 100 according to one embodiment of the present disclosure may operate through a pinch-out operation or another gesture operation set by the user as well as the pinch-in operation.

An instruction set for each of these operations may be stored as one or more modules in the above-described memory 110. In this case, the modules stored in the memory 110 may be executed by the one or more processors 122.

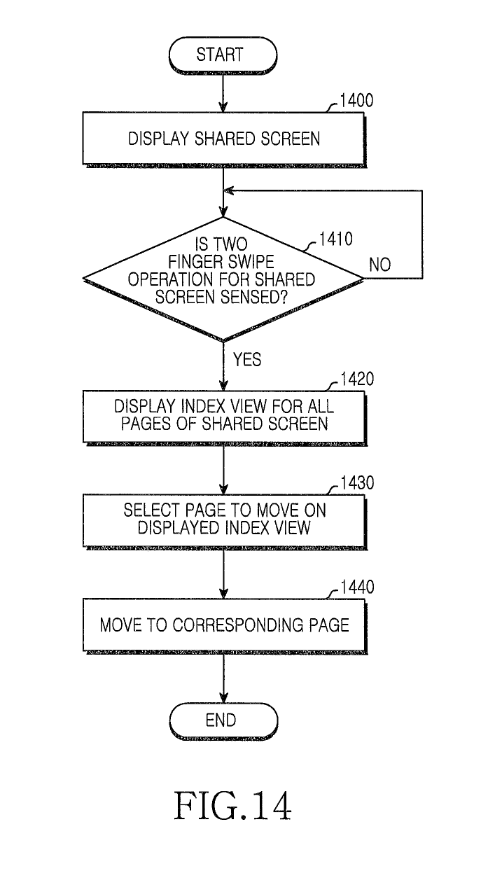

FIG. 14 is a flowchart illustrating an operation method of an electronic device according to another embodiment of the present disclosure.

Referring to FIGS. 2 and 14, the electronic device 100 may display a shared screen in step 1400.

In accordance with one embodiment of the present disclosure, the electronic device 100 may display a shared screen including one or more pages, each of them including contents, on the screen of the electronic device 100. For example, as shown in FIG. 5C, the shared screen may be implemented.

Thereafter, the electronic device 100 may determine whether to sense a two finger swipe operation for the shared screen in step 1410.

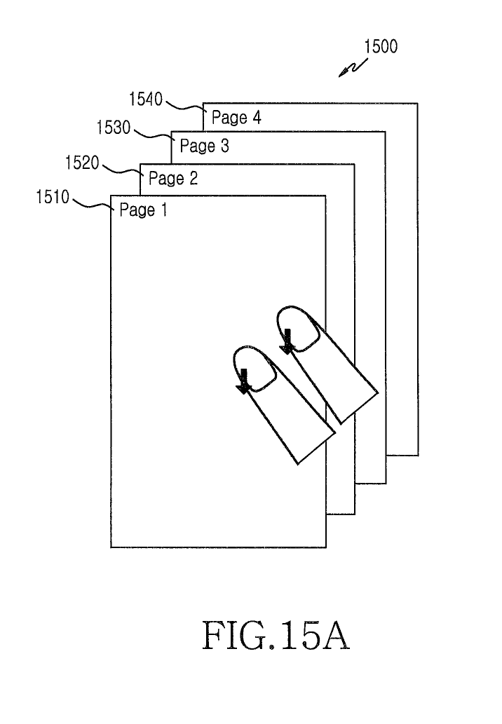

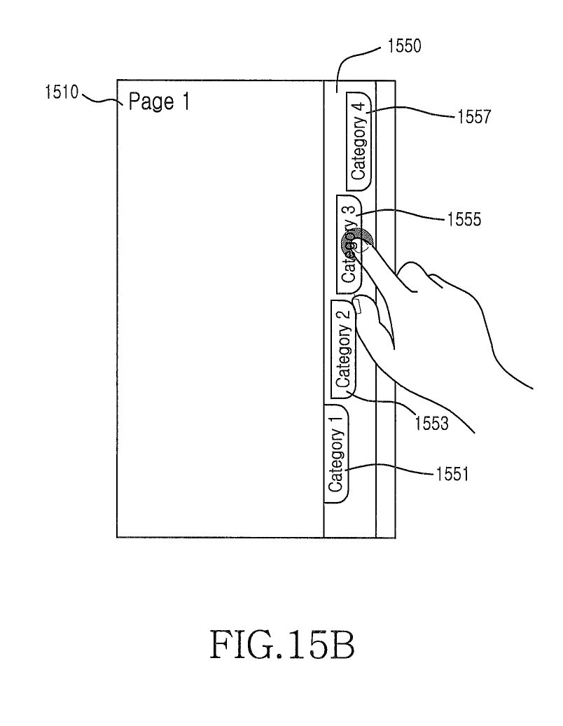

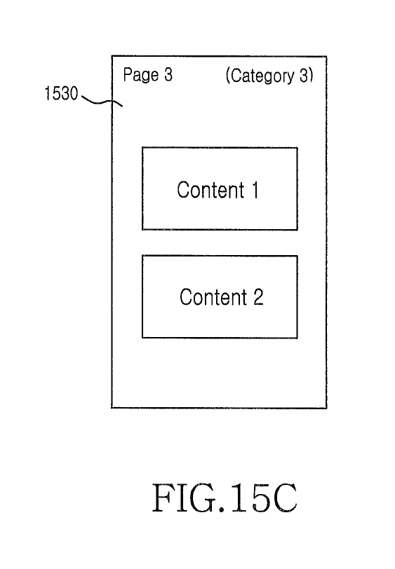

As shown in FIG. 15A, the electronic device 100 may sense a swipe operation for touching two fingers of the user on the screen of the electronic device 100 in each of pages 1510, 1520, 1530, and 1540 of a shared screen 1500 and being performed in the same direction. For example, this two finger swipe operation may be set to be sensed in only a specific region.

Sensing the two finger swipe operation for the shared screen, the electronic device 100 may display an index view for all pages of the shared screen in step 1420.

As shown in FIG. 15B, the electronic device 100 may display an index view 1550 in which the pages 1510, 1520, 1530, and 1540 of the shared screen 1500 are iconed. The index view 1550 may be displayed on, but is not limited to, a right region of the current screen 1510. This index view 1550 may display category information 1551, 1553, 1555, 1557 corresponding to the pages 1510, 1520, 1530, and 1540 of the shared screen 1500 together. For example, this category information 1551, 1553, 1555, and 1557 may be disposed on a specific region of the index view 1550 or at a certain interval on the index view 1550. Shapes and positions of the category information 1551, 1553, 1555, and 1557 may be also set by the user.

Also, the category information 1551, 1553, 1555, and 1557 may be arranged in order of high priority or according to settings of the user.

Thereafter, the electronic device 100 may select a page to move on the displayed index view in step 1430.

As shown in FIG. 15B, the user of the electronic device 100 may select desired category information 1555 among the category information 1551, 1553, 1555, and 1557 of the index view 1550.

Thereafter, the electronic device 100 may move to the corresponding page in step 1440.

As shown in FIG. 15C, the electronic device 100 may display a corresponding page 1530 corresponding to the selected category information 1535. That is, the user may verify whether a desired category is included in any page and move to the corresponding page immediately.

In accordance with one embodiment of the present disclosure, the description was given for, but is not limited to, the method of moving to the desired page through the two finger swipe operation. For example, the electronic device 100 according to one embodiment of the present disclosure may operate through a double tab operation or another gesture operation set by the user as well as the two finger swipe operation.

An instruction set for each of these operations may be stored as one or more modules in the above-described memory 110. In this case, the modules stored in the memory 110 may be executed by the one or more processors 122.

In accordance with various embodiments of the present disclosure, the electronic device may improve security and provide a user interface for intuitively operating contents.

In accordance with one embodiment of the present disclosure, respective modules may be configured by software, firmware, hardware, or combination of them. Some or all of modules may be configured in one entity and functions of the respective modules may be equally performed. In accordance with one embodiment of the present disclosure, respective operations may be executed successively, repeatedly, or in parallel. Some operations may be omitted or other operations may be added and executed. For example, the respective operations may be executed by corresponding modules described in one embodiment of the present disclosure.

When the method is implemented by the software, a non-transient computer-readable storage medium for storing one or more programs (software modules) may be provided. The one or more programs stored in the computer-readable storage medium may be executed by the one or more processors in the electronic device. The one or more programs include instructions for allowing the electronic device to execute the methods according to various embodiments of the present disclosure.

These programs (software module, software) may be stored in a Random Access Memory (RAM), a non-volatile memory including a flash memory, a Read Only Memory (ROM), an Electrically Erasable Programmable ROM (EEPROM), a magnetic disc storage device, a Compact Disc-ROM (CD-ROM), a Digital Versatile Disc (DVD) or an optical storage device of a different type, and a magnetic cassette. Or, the programs may be stored in a memory configured by combination of some or all of them. Also, the configured memory may include a plurality of memories.

Also, the programs may be stored in an attachable storage device which may access the electronic device through each of communication networks such as the Internet, an intranet, Local Area Network (LAN), a Wide LAN (WLAN), and a Storage Area Network (SAN) or a communication network configured by combination of them. This storage device may connect to the electronic device through an external port device.

Also, a separate storage device on a communication network may connect to the electronic device.

While the present disclosure has been particularly shown and described with reference to exemplary embodiments thereof, it will be understood by those skilled in the art that various changes in form and details may be made therein without departing from the spirit and scope of the present disclosure as defined by the appended claims.

What is claimed is:

1. A method of operating an electronic device, the method comprising:
displaying a shared screen including one or more pages, each of the one or more pages including contents;
transmitting the shared screen to a server; and
receiving an update shared screen including update contents based on the contents of the shared screen from the server,
wherein the update contents are updated by one or more other electronic devices.

2. The method of claim 1, further comprising transmitting an invitation message to the one or more other electronic devices when transmitting the shared screen to the server.

3. The method of claim 2, further comprising receiving a response message to the invitation message from the one or more other electronic devices.

4. The method of claim 1, further comprising transmitting the update contents to the server and updating the contents of the server when the one or more other electronic devices generate the update contents.

5. The method of claim 1, wherein the one or more pages include at least one of a home screen and a lock screen of the electronic device.

6. The method of claim 5, further comprising displaying a title for the contents on at least one of the home screen and the lock screen.

7. The method of claim 1, wherein the one or more pages are applied to predetermined templates.

8. The method of claim 1, further comprising determining whether to sense a reference gesture for any one of the one or more pages.

9. The method of claim 8, further comprising summarizing and displaying the one or more pages when the reference gesture is sensed.

10. An electronic device comprising:
a touch screen;
a memory; and
at least one processor,
wherein at least the one processor is configured to
cause the touch screen to display a shared screen including one or more pages, each of the one or more pages including contents;
cause transmission of the shared screen to a server; and
receive an update shared screen including update contents based on the contents of the shared screen from the server,
wherein the update contents are updated by one or more other electronic devices.

11. The electronic device of claim 10, wherein at least the one processor is configured to cause transmission of an invitation message to the one or more other electronic devices when transmitting the shared screen to the server.

12. The electronic device of claim 11, wherein at least the one processor is configured to receive a response message to the invitation message from the one or more other electronic devices.

13. The electronic device of claim 10, wherein the one or more pages include at least one of a home screen and a lock screen of the electronic device.

14. The electronic device of claim 13, wherein at least the one processor is configured to cause the touch screen to display a title for the contents on at least one of the home screen and the lock screen.

15. The electronic device of claim 10, wherein at least the one processor is configured to apply predetermined templates to the one or more pages.

16. The electronic device of claim 10, wherein at least the one processor is configured to determine whether to sense a reference gesture for any one of the one or more pages.

17. The electronic device of claim 16, wherein at least the one processor is configured to summarize and display the one or more pages when the reference gesture is sensed.

18. A method of operating a server, the method comprising:
receiving a shared screen including one or more pages, each of the one or more pages including contents from an electronic device;
transmitting the shared screen to another electronic device;
receiving an update shared screen including update contents for contents of the shared screen from the other electronic device; and
transmitting the update shared screen to the electronic device.

19. The method of claim 18, further comprising receiving a user log of the electronic device from the electronic device.

20. A non-transitory computer-readable medium storing embodied thereon one or more programs comprising instructions to cause an electronic device to perform the method of claim 1, when the instructions will be executed by the electronic device.
